(19) United States
(12) Patent Application Publication
(10) Pub. No.: US 2026/0337375 A1
(43) Pub. Date: Oct. 29, 2026

(54) POLYMER COMPOSITION AND METHOD OF MAKING

(71) Applicant: SAINT-GOBAIN PERFORMANCE PLASTICS CORPORATION, Malvern, PA (US)

(72) Inventors: Zichao WEI, Brighton, MA (US); Shuai LIANG, Southborough, MA (US); Michael J. TZIVANIS, Chicopee, MA (US); Hua WANG, Northbridge, MA (US); Kosuke YOSHINAGA, Cambridge, MA (US); Heidi LENNON, Shrewsbury, MA (US); Nicolas DROLET, Chelmsford, MA (US)

(21) Appl. No.: 19/658,181

(22) Filed: Apr. 24, 2026

Related U.S. Application Data
(60) Provisional application No. 63/794,779, filed on Apr. 25, 2025.

(51) Int. Cl. C08K 3/36

(52) U.S. Cl. CPC C08K 3/36; C08K 2201/006; C08K 2201/011

(57) ABSTRACT

The subject application relates to an article including a polymer composition and bio-based silica particles. Further included is a method of extracting the bio-based silica particles from a biomass source.

### CROSS-REFERENCE TO RELATED APPLICATION(S)

This application claims priority under 35 U.S.C. § 119(e) to U.S. Provisional Patent Application No. 63/794,779 entitled “POLYMER COMPOSITION AND METHOD OF MAKING,” filed Apr. 25, 2025, by Zichao WEI et al., which is assigned to the current assignee hereof and is incorporated herein by reference in its entirety.

### FIELD OF THE DISCLOSURE

This disclosure, in general, relates to a polymer composition, such as a silicone composition, and method of forming the silicone composition.

### BACKGROUND

Polymeric materials are widely used for their properties desired in the medical, pharmaceutical, food, and biological industries. For instance, silicone-containing polymeric materials typically are non-toxic, flexible, thermally stable, have low chemical reactivity, and can be produced in a variety of sizes. Typical polymeric commercial formulations include a multi-component mixture of monomeric starting materials, catalysts, crosslinkers, and fillers. The specific components are dependent upon the final polymer composition desired. With polymeric materials, the widespread use creates issues with consumption, waste, and environmental considerations.

Accordingly, it would be advantageous to decrease the carbon footprint when producing polymeric materials. In a particular embodiment, a lower carbon footprint silicone-based article is desired that has advantageous mechanical and physical properties.

### SUMMARY

In an embodiment, an article includes a polymer composition, the polymer composition including a polymer matrix and bio-based silica particles, wherein the article has a shore A durometer of about 20 to about 90, as measured by ASTM D2240.

In an embodiment, a method of providing an article including a silicone composition includes: providing at least one organosiloxane and bio-based silica particles; and shaping the silicone composition into an article.

In an embodiment, a method of extracting a population of bio-based silica particles includes: a) providing a biomass source; b) adding the biomass source to an aqueous acidic solution; c) removing the biomass source from the aqueous acidic solution; d) heating the biomass source to a temperature of at least 700 °C; and e) recovering a plurality of individual bio-based silica particles.

In another embodiment, a tube includes a silicone composition, the silicone composition including at least one organosiloxane and bio-based silica particles.

### BRIEF DESCRIPTION OF THE DRAWINGS

The present disclosure may be better understood, and its numerous features and advantages made apparent to those skilled in the art by referencing the accompanying drawings.

FIG. 1 includes an illustration of an exemplary tube.

FIG. 2 includes FTIR spectra of exemplary bio-mass silica.

The use of the same reference symbols in different drawings indicates similar or identical items.

### DETAILED DESCRIPTION

The following description in combination with the figures is provided to assist in understanding the teachings disclosed herein. The following discussion focuses on specific implementations and embodiments of the teachings. This focus is provided to assist in describing the teachings and should not be interpreted as a limitation on the scope or applicability of the teachings.

As used herein, the terms “comprises”, “comprising”, “includes”, “including”, “has”, “having”, or any other variation thereof, are open-ended terms and should be interpreted to mean “including, but not limited to . . . ”. These terms encompass the more restrictive terms “consisting essentially of” and “consisting of.” In an embodiment, a method, article, or apparatus that comprises a list of features is not necessarily limited only to those features but may include other features not expressly listed or inherent to such method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” is employed to describe elements and components described herein. This is done merely for convenience and to give a general sense of the scope of the invention. This description should be read to include one or at least one and the singular also includes the plural, or vice versa, unless it is clear that it is meant otherwise. For example, when a single item is described herein, more than one item may be used in place of a single item. Similarly, where more than one item is described herein, a single item may be substituted for that more than one item.

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and may be found in reference books and other sources within the structural arts and corresponding manufacturing arts. Unless indicated otherwise, all measurements are at ambient temperature. For instance, values for ambient temperature are at 20 °C+/−5 °C, unless indicated otherwise.

In a particular embodiment, an article is provided. The article includes a polymer composition including a polymer matrix and bio-based silica particles. “Bio-based silica particles” as used herein refers to silica particles that are derived from a plant. The polymer composition including the bio-based silica particles advantageously provides a polymer composition having a carbon dioxide emission that is decreased significantly compared to a polymer composition absent the bio-based silica particles. Further, desirable mechanical properties are achieved with the use of the bio-based silica particles. For instance, the polymer composition has a tear strength of 14 N/mm to 100 N/mm as measured by ASTM 624 (Die C no slit).

Any polymer composition is envisioned. In an embodiment, the polymer composition forms a polymer matrix, i.e., a continuous phase of material wherein the bio-based silica particles are mixed throughout. In an embodiment, the polymer matrix includes, for example, a silicone elastomer, a polystyrene, a polyester, a silicone copolymer, silicone thermoplastic vulcanizate, a copolyester, a polyamide, a fluoropolymer, a polyethylene, a polypropylene, a polyether-ester copolymer, a thermoplastic urethane, a polyether amide block (PEBA) copolymer, a polyamide copolymer, a styrene block copolymer, a polycarbonate, a polyolefin elastomer, a thermoplastic vulcanizate, an ionomer, a polyoxymethylene (POM), an acrylonitrile butadiene styrene (ABS), an acetal, an acrylic, a polyvinyl chloride (PVC), a silane modified copolymer, a silane modified homopolymer, an epoxy, a urea-formaldehyde thermoset polymer, a phenol formaldehyde thermoset polymer, a blend, or combination thereof.

In an embodiment, the polymer composition is a silicone composition, such as a silicone elastomer. In a particular embodiment, the silicone composition includes at least one organosiloxane. Any organosiloxane is envisioned. In an embodiment, the at least one organosiloxane includes, for instance, a hydride-containing alkylsiloxane, a vinyl-containing alkylsiloxane, an aryl-containing alkylsiloxane, a hydroxy-containing alkylsiloxane, a halogen-containing alkylsiloxane, or combination thereof. In an embodiment, the at least one organosiloxane may include any alkyl group, such as any C1-6 alkyl group or combination thereof. In an embodiment, the aryl group of the aryl-containing alkylsiloxane may include any number of carbon groups such as 3 to 12 aryl groups. In an embodiment, the at least one organosiloxane includes a hydride-containing alkylsiloxane and a vinyl-containing alkylsiloxane. In an embodiment, exemplary organosiloxanes include, for instance, a dimethylsiloxane, a diethylsiloxane, a dipropylsiloxane, a methylethylsiloxane, a methylpropylsiloxane, or combinations thereof.

In an example, the at least one organosiloxane may include a halide functional group, a phenyl functional group, or combination thereof. For example, the at least one organosiloxane may include a fluorine group or a phenyl group. Alternatively, the at least one organosiloxane is non-polar and is free of a halide functional group, such as chlorine and fluorine, and of a phenyl functional group.

In an embodiment, the at least one organosiloxane is present at 0.1 to 99 wt. %, such as 1 to 95 wt. %, or even 5 to 90 wt. % of the total weight of the silicone composition. In a more particular embodiment, the at least one organosiloxane is present at an amount of at least 0.1 wt. %, or at least 1 wt. %, or at least 5 wt. %, or at least 10 wt. %, or at least 15 wt. %, or at least 20 wt. %, or at least 25 wt. %, or at least 30 wt. %, or not greater than 99 wt. %, or not greater than 98 wt. %, or not greater than 97 wt. %, or not greater than 96 wt. %, or not greater than 95 wt. %, or not greater than 90 wt. %, or not greater than 85 wt. %, or not greater than 80 wt. % of the total weight of the silicone composition. It will be appreciated that the amount of the at least one organosiloxane can be within a range between any of the minimum and maximum values noted above.

The bio-based silica particles are further included in the polymer composition. Typically, the bio-based silica particles are used as filler to provide desirable properties such as, for example, viscosity during processing of the components of the polymer composition, mechanical strength, dimensional stability, and the like. The “bio-based silica particles” as used herein refers to a plant-based particles derived from a biomass source such as rice husks, wheat hulls, bamboo leaves, sugarcane bagasse, straw, barley husk, wheat straw, horsetail, sponges, oat hulls, corn stovers, nettle, hemp, musa, or combination thereof. The use of the bio-based silica particles reduces the carbon dioxide emissions and the total carbon footprint of the polymer composition.

The bio-based silica particles are extracted from the biomass source by any reasonable method. In an embodiment, a method of extracting a population of bio-based silica particles includes: a) providing the biomass source; b) adding the biomass source to an aqueous acidic solution; c) removing the biomass source from the aqueous acidic solution; d) heating the biomass source to a temperature of at least 700 °C, such as 700 °C to 900 °C; and e) recovering a plurality of individual bio-based silica particles. Any acidic solution is envisioned, such as any reasonable solution having a pH of less than 7 at a molar concentration of 0.1 to 10, such as 1 to 8, or even 1 to 5. In an embodiment, the acidic solution includes hydrochloric acid. The biomass source is in the aqueous acidic solution for any reasonable time, such as at least 30 minutes, such as 30 minutes to 180 minutes, or even 30 minutes to 120 minutes. It will be appreciated that the values of the conditions for the method can be within a range between any of the minimum and maximum values noted above.

In an embodiment, the heating of the biomass source may be with favorable conditions to provide desirable particles. The heating is at a temperature to remove the organic components from the biomass source. In an embodiment, a continuous airflow of 0.1 m/s to 0.5 m/s is maintained during heating of the biomass source in an atmosphere of air or an inert gas. The inert gas includes, for instance, nitrogen, argon, the like, or combination thereof. In an embodiment, the airflow is particularly suited for calcination and to provide advantageous physical properties. In an embodiment and after heating, the silica particles can be recovered without any further treatments. Any method of recovery is envisioned.

The method of extracting the bio-based silica particles provides desirable physical properties. For instance, the bio-based silica particles have a surface area of 15 m²/g to 400 m²/g, such as 50 m²/g to 400 m²/g, such as 100 m²/g to 400 m²/g, such as 150 m²/g to 400 m²/g, such as 200 m²/g to 400 m²/g, such as 250 m²/g to 400 m²/g, or even 300 m²/g to 400 m²/g, as measured by BET. In an embodiment, the bio-based silica particles have a purity of at least 95%, such as 95% to 99%, as measured by ICP. For instance, due to the bio-based silica particles originating from a biomass source, traces of elements such as barium and calcium are distinct and are measurable by ICP. In contrast, commercially available, non-bio-based silica particles are absent any trace elements of barium and calcium. For instance, commercially available, non-bio-based silica particles typically have a purity of greater than 99%, such as at least 99.1%, such as at least 99.2%, such as at least 99.3%, such as at least 99.4%, or even at least 99.5%, as measured by ICP. Further, the bio-based silica particles are amorphous, as measured by X-Ray Diffraction (XRD). In an embodiment, the bio-based silica particles have an average particle size of 2 nanometers to 100 nanometers, such as 2 nanometers to 90 nanometers, such as 2 nanometers to 80 nanometers, such as 2 nanometers to 70 nanometers, such as 2 nanometers to 60 nanometers, such as 2 nanometers to 50 nanometers, such as 2 nanometers to 40 nanometers, such as 2 nanometers to 30 nanometers, such as 2 nanometers to 20 nanometers, or even 2 nanometers to 10 nanometers, as measured by SEM. It will be appreciated that the values for the physical properties can be within a range between any of the minimum and maximum values noted above.

Any amount of bio-based silica particles is envisioned. In an embodiment, the bio-based silica particles are present in an amount of 1 wt. % to 60 wt. %, such as 5 wt. % to 55 wt. %, or even 10 wt. % to 50 wt. %, based on the total weight of the polymer composition. In an embodiment, the bio-based silica particles are present in an amount of 1 wt. % to 45 wt. %, such as 5 wt. % to 40 wt. %, or even 10 wt. % to 30 wt. %, based on the total weight of the silicone composition. It will be appreciated that the amount of filler can be within a range between any of the minimum and maximum values noted above.

In an embodiment, any surface treatment of the bio-based silica particles is envisioned. For instance, any surface treatment is envisioned that provides at least one benefit of, for example, enhanced adhesion, enhanced homogeneity, reduced hydrogen bonding to the silicone composition, or any combination thereof. An exemplary surface treatment can include any wet or dry chemical reaction, physical absorption, plasma treatment, chemical etching, coating, encapsulation, mechanical mixing, or any combination thereof. In an embodiment, the surface treatment is a silane treatment. In an example, the silane treatment may improve the final properties of the article such as, for instance, an increase in the tear strength of the article.

In an embodiment, bio-based silica particles may also be reacted with any reasonable reagent. The reagent may include, but is not limited to, an amino-functional reagent such as 3-Aminopropyltriethoxysilane (APTES), N-(2-Aminoethyl)-3-aminopropyltrimethoxysilane (AEAPTMS); an epoxy-functional reagent such as 3-Glycidyloxypropyltrimethoxysilane (GPTMS); a methacrylate-functional reagent such as 3-(Trimethoxysilyl)propyl methacrylate (MEMO); a vinyl/thiol-functional reagent such as vinyltrimethoxysilane (VTMS), 3-Mercaptopropyltrimethoxysilane (MPTMS); a halogen-functional reagent such as trimethylchlorosilane (TMCS); hexamethyldisilazane (HMDS); 1H,1H,2H,2H-Perfluorooctyltriethoxysilane (PFTS); a titanate such as isopropyl tri(dioctyl)pyrophosphate titanate (e.g., Ken-React LICA 38), neopentyl(diallyl)oxy tri(dioctyl)phosphato titanate; a zirconate such as neopentyl(diallyl)oxy tri(dioctyl)phosphato zirconate (e.g., NZ 44); stearic acid (octadecanoic acid); oleic acid (cis-9-octadecenoic acid); citric acid (2-hydroxypropane-1,2,3-tricarboxylic acid); an ionic surfactant such as cetyltrimethylammonium bromide (CTAB), sodium dodecyl sulfate (SDS); a non-ionic surfactant such as polyethylene glycol tert-octylphenyl ether (Triton X-100), polyoxyethylene (20) sorbitan monolaurate (Tween 20), polyethylene glycol (PEG), polyvinylpyrrolidone (PVP), polymethyl methacrylate (PMMA), chitosan (poly-D-glucosamine), polydopamine (polymerized dopamine), polydimethylsiloxane (PDMS), and triethoxysilylpropyl succinic anhydride (functional alkoxysilane); or any combination thereof.

With a conventional, commercially prepared silicone formulation, the commercially prepared silicone formulation typically includes components such as at least two organosiloxanes that polymerize in the presence of the bio-based silica particles, a catalyst, a crosslinker, an inhibitor, optional additives, and the like.

Typically, the catalyst is present to initiate the crosslinking process. Any catalyst is envisioned depending upon the polymer composition. For instance, when the polymer composition is a silicone composition, the catalyst includes a hydrosilylation reaction catalyst. For instance, an exemplary hydrosilylation catalyst is an organometallic complex compound of a transition metal. In an embodiment, the catalyst includes platinum, rhodium, ruthenium, the like, or combination thereof. In a particular embodiment, the catalyst includes platinum. Further, other catalysts may be envisioned. Exemplary catalysts may include peroxide, tin, or combination thereof. In an embodiment, the catalyst may be present at greater than 0.1 wt. %, such as 0.1 to 5 wt. %, or even 1 to 3 wt. % of the total weight of the silicone composition. In a more particular embodiment, the catalyst is present at an amount of at least 0.1 wt. %, or at least 0.5 wt. %, or at least 1.0 wt. %, or at least 1.5 wt. %, or at least 2.0 wt. %, or at least 2.5 wt. %, or at least 3.0 wt. %, or at least 3.5 wt. %, or not greater than 5 wt. %, or not greater than 4.5 wt. %, or not greater than 4.0 wt. %, or not greater than 3.5 wt. %, or not greater than 3.0 wt. %, or not greater than 2.5 wt. %, or not greater than 2.0 wt. %, or not greater than 1.5 wt. % of the total weight of the silicone composition. It will be appreciated that the amount of catalyst can be within a range between any of the minimum and maximum values noted above.

The polymer composition may further include an additive. Any reasonable additive is envisioned. Exemplary additives may include, individually or in combination, a curing agent, a crosslinker, an adhesion promoter, an initiator, an inhibitor, a colorant, a pigment, a carrier material, an anti-microbial, or any combination thereof. In an embodiment, the crosslinker includes any reasonable compound having at least two functional groups, including, but not limited to, hydride, siloxane, vinyl, methoxy, ethoxy, oxime, sulfide, thiolate, acrylate, methyl acrylate, amine, boro ether, metal complex, or combination thereof. In an embodiment, the polymer composition is substantially free of an additive, such as present at less than 0.1 wt. % of an additive based on the total weight of the polymer composition. In some embodiments, the silicone composition consists essentially of the at least one organosiloxane, the bio-based silica particles, and catalyst described above. As used herein, the phrase “consists essentially of” used in connection with the silicone composition precludes the presence of non-silicone polymers that affect the basic and novel characteristics of the silicone composition, although, commonly used processing agents and additives may be used in the silicone composition. In an embodiment, the silicone composition consists of the at least one organosiloxane, the bio-based silica particles, and catalyst described above.

In an embodiment, the polymer composition has a number-average molecular weight of at least 50 g/mol, such as 50 g/mol to 1,000,000 g/mol, such as 200,000 g/mol to 1,000,000 g/mol, such as at least 200,000 g/mol, or at least 300,000 g/mol, or at least 400,000 g/mol, or at least 500,000 g/mol, or not greater than 1,000,000 g/mol, or not greater than 800,000 g/mol, or not greater than 600,000 g/mol, or not greater than 400,000 g/mol as measured by a gas permeation chromatography (GPC) in THF. In a particular embodiment, the number-average molecular weight of the polymer composition is 200,000 g/mol to 1,000,000 g/mol. It will be appreciated that the properties can be within a range between any of the minimum and maximum values noted above.

In an embodiment, the polymer composition has a weight-average molecular weight of at least 50 g/mol, such as 50 g/mol to 1,000,000 g/mol, such as 200,000 g/mol to 1,000,000 g/mol, such as at least 200,000 g/mol, or at least 300,000 g/mol, or at least 400,000 g/mol, or at least 500,000 g/mol, or not greater than 1,000,000 g/mol, or not greater than 800,000 g/mol, or not greater than 600,000 g/mol, or not greater than 400,000 g/mol as measured by a gas permeation chromatography (GPC) in THF. In a particular embodiment, the weight-average molecular weight of the polymer composition is 200,000 g/mol to 1,000,000 g/mol. It will be appreciated that the properties can be within a range between any of the minimum and maximum values noted above.

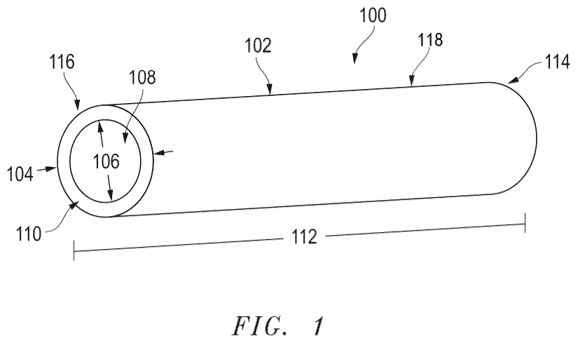

FIG. 1 is a view of an exemplary article, such as a tube 100 according to an embodiment. In a particular embodiment, the tube 100 can include a body 102 having an outside diameter 104 and an inner diameter 106. The inner diameter 106 can form an inner surface 108 of the body 102. The inner surface 108 defines a central lumen of the tube. In addition, the body 102 is illustrated as a single layer, the single layer including the polymer composition, such as the silicone composition. The layer can include a thickness 110 that is measured by the difference between the outside diameter 104 and the inner diameter 106.

Any reasonable outside diameter 104 is envisioned. In a particular embodiment, the outside diameter 104 of the body 102 is about 0.09 inches (2.286 mm) to about 5 inches (127 mm). It will be appreciated that the outside diameter 104 can be within a range between any of the minimum and maximum values noted above. Any reasonable inside diameter 106 is envisioned. In an embodiment, the inner diameter 106 of the body 102 is about 0.005 inches (0.127 mm) to about 4 inches (101.6 mm), with the proviso that the inner diameter 106 is less than the outer diameter 104. It will be appreciated that the inner diameter 106 can be within a range between any of the minimum and maximum values noted above.

Further, the body 102 can have a length 112, which is a distance between a distal end 114 and a proximal end 116 of the tube 100. Any reasonable length 112 is envisioned. In a further embodiment, the length 112 of the body 102 can be at least 0.1 meters, such as at least 1 meter, such as at least 2 meters, such as at least 5 meters, or even greater than 10 meters. The length 112 is generally limited by pragmatic concerns, such as storing and transporting long lengths, or by customer demand. Further, the body 102 has a surface 118. The surface 118 can be an outer surface of the tube 100.

Although the cross-section of the hollow bore 108 perpendicular to an axial direction of the body 102 in the illustrative embodiment shown in FIG. 1 has a circular shape, the cross-section of the hollow bore 108 perpendicular to the axial direction of the body 102 can have any cross-section shape envisioned.

Although illustrated as a single layer tube, any number of layers is envisioned. For instance, the tube includes one layer, two layers, three layers, or even a greater number of layers. Typically, the layer has a thickness of at least about 0.05 mm to about 10 mm. It will be appreciated that the thickness of the layer can be within a range between any of the minimum and maximum values noted above. Irrespective of the number of layers present, the outside diameter and inner diameter of the tube can have any values as defined for the single layer tube 100 defined in FIG. 1. The number of layers is dependent upon the final properties desired for the tube. Any configuration or location of the layer including the polymer composition, such as the silicone composition, is envisioned within the article.

In an embodiment, the polymer composition may be formed into a single layer article, a multi-layer article, or can be laminated, coated, or formed on a substrate. Multi-layer articles may include layers such as a polymeric layer, a reinforcing layer, an adhesive layer, a barrier layer, a chemically resistant layer, a metal layer, any combination thereof, and the like. When the article is a tube and the tube includes multiple layers, each of the individual layers of the tube may be formed by any reasonable means and is dependent upon the material and the configured location of each of the individual layers. Any number of layers is also envisioned. Although primarily described as a tube, the polymer composition can be formed into any useful shape such as film, sheet, tubing, and the like. The polymer composition may adhere or bond to other substrates including other polymers.

Any other polymer layer includes, for instance, an elastomeric polymer. Exemplary elastomeric polymers are envisioned and include, for example, a silicone elastomer, a polystyrene, a polyester, a silicone copolymer, silicone thermoplastic vulcanizate, a copolyester, a polyamide, a fluoropolymer, a polyethylene, a polypropylene, a polyether-ester copolymer, a thermoplastic urethane, a polyether amide block (PEBA) copolymer, a polyamide copolymer, a styrene block copolymer, a polycarbonate, a polyolefin elastomer, a thermoplastic vulcanizate, an ionomer, a polyoxymethylene (POM), an acrylonitrile butadiene styrene (ABS), an acetal, an acrylic, a polyvinyl chloride (PVC), a blend, or combination thereof.

In an embodiment, the polymer composition, such as the silicone composition, may be formed by any reasonable means depending upon the final article desired. In an embodiment, the silicone composition is formed into a tube by extrusion or injection molding followed by cure such as thermal cure, radiation cure, or combination thereof.

In an exemplary embodiment, the polymer composition, such as the silicone composition, is formed by an extrusion system. The extrusion system for the polymer composition typically includes a pumping system and can include a number of devices that can be utilized to form the article. For example, the extrusion system can include a pumping device such as a gear pump, a static mixer, an extruder, a tube die, a thermal cure device, a radiation cure device, a post-processing device, or any combination thereof. The method includes receiving, by an extrusion system, the mixed polymer composition as described above. Any reasonable mixing apparatus is envisioned. In a particular embodiment and when forming the silicone composition, the mixing apparatus forms a homogenous mixture of the at least one organosiloxane with a homogenous distribution of the bio-based silica particles. In an embodiment, heat may also be applied to the components of the polymer composition. The heat is a reasonable temperature depending on the component of the polymer composition. For instance, any reasonable heating temperature for the components of the silicone composition may be used to provide a material that can flow from the pumping system and extruded through the tube die without degradation of the material. For instance, the temperature may be about 10 °C to about 70 °C. It will be appreciated that the heating temperature can be within a range between any of the minimum and maximum values noted above. Typically, the silicone composition is mixed and pumped, i.e. extruded, through the tube die of the extrusion system.

In an alternative embodiment, the article is formed by an injection molding system. The injection molding system includes any pumping system to deliver the polymer composition such as pneumatically, hydraulically, gravitationally, mechanically, and the like, or combination thereof. The pumping system delivers the polymer composition to a mold configured in any shape desired for the final article, such as a tube. The pumping system may also include any reasonable mixing apparatus envisioned. In a particular embodiment and when using a silicone composition, the mixing apparatus forms a homogenous mixture of the at least one organosiloxane and the bio-based silica particles. Further, the pumping system may include a method of heating any combination of the components of the polymer composition to any temperature envisioned so that it has a desirable viscosity for delivery such that the polymer composition may flow into the mold. The injection molding system may further include a thermal cure device, a radiation cure device, a post-processing device, or any combination thereof.

In an embodiment, the polymer composition is thermally cured. In an embodiment, the thermal curing of the polymer composition can include subjecting the polymer composition to one or more heat sources. In a particular embodiment, the heat source is sufficient to substantially cure the polymer composition. “Substantially cure” as used herein refers to 90% to 100% curing degree, as determined for instance by rheometer data (90% cure means the material reaches 90% of the maximum torque as measured by ASTM D5289). For instance, the level of cure is to provide desirable properties for the final article.

In an embodiment, the polymer composition is radiation cured. Any number of applications of radiation energy may be applied with the same or different wavelengths. For example, the extrusion system or injection molding system can include one or more ovens (e.g. infrared (IR) ovens, air ovens), one or more baths (e.g. water baths), or a combination thereof, to cure the silicone composition. The one or more IR ovens can operate at a particular peak wavelength. In certain instances, the peak wavelength of a first IR oven can be different from the peak wavelength of a second IR oven. In an embodiment, the polymer composition can be subjected to a heat treatment for a specified period of time. In a particular embodiment, the polymer composition can be subjected to curing in a first IR oven for a first period of time and then subject to curing in a second IR oven for a second period of time that is different from the first period of time. In one particular embodiment, use is made of a short wavelength IR oven. By short wavelength, it is meant that the peak wavelength is below 4 microns, typically below 3 microns, such as within a range of approximately 0.6 to 2.0 microns, such as 0.8 to 1.8 microns. Generally medium and longer wavelength IR ovens are characterized by a peak wavelength on the order of 4 to 8 microns, or even higher. It will be appreciated that the wavelength can be within a range between any of the minimum and maximum values noted above.

Once the polymer composition is formed, the polymer composition can undergo one or more post processing operations. Any reasonable post processing operations are envisioned. For instance, the polymer composition, such as the silicone composition, can be subjected to a post-cure heat treatment, such as a post-curing cycle. Post thermal treatment typically occurs at a temperature of about 40 °C to about 200 °C. In an embodiment, the post thermal treatment is at a temperature of about 60 °C to about 100 °C. Typically, the post thermal treatment occurs for a time period of about 5 minutes to about 10 hours, such as about 10 minutes to about 30 minutes, or alternatively about 1 hour to about 4 hours. It will be appreciated that the post thermal treatment temperature and time can be within a range between any of the minimum and maximum values noted above. In an alternative example, the polymer composition is not subjected to a post thermal treatment. In an example, the article is a tube that can be cut into a number of tubes having a specified length. In another embodiment, the post processing can include wrapping the tube into a coil of tubing.

The article can be sterilized. In an embodiment, the article may be sterilized by any method envisioned. For instance, the tube is sterilized after it is formed. Exemplary sterilization methods include hydrogen peroxide, autoclave, gamma, ethylene oxide, electron beam techniques, combinations thereof, and the like. In a particular embodiment, the article is sterilized by gamma irradiation. For instance, the article may be gamma sterilized at between about 10 kGy to about 200 kGy. In a particular embodiment, the article is sterilized by steam sterilization. In an exemplary embodiment, the article is heat-resistant to steam sterilization at temperatures up to about 130 °C for a time of up to about 45 minutes. In an embodiment, the article is heat resistant to steam sterilization at temperatures of up to about 135 °C for a time of up to about 15 minutes. It will be appreciated that the sterilization parameters can be within a range between any of the minimum and maximum values noted above.

In an embodiment, the resulting article may have further desirable physical and mechanical properties. For instance, the article is flexible and kink-resistant. In particular, the resulting article has desirable flexibility. For instance, the silicone composition may advantageously produce low durometer articles. For example, an article having a Shore A durometer of between about 20 and about 90, such as between about 35 to about 75 as measured by ASTM D2240 having desirable mechanical properties may be formed. Such properties are indicative of a flexible material. In an embodiment, the silicone composition has at least one of the following properties: a) a tear strength greater than 15 N/mm, such as greater than 18 N/mm, or even greater than 20 N/mm, as measured by ASTM 624 (Die C no slit); b) a tear strength that is increased by at least 5%, such as at least 10%, such as at least 20%, such as at least 30%, such as at least 40%, such as at least 50%, such as at least 60%, or even at least 70% compared to a polymer composition absent a bio-based silica particle; c) an elongation at break of at least greater than 150%, such as greater than 250%, such as greater than 350%, such as greater than 450%, such as greater than 550%, such as greater than 650%, such as greater than 750%, such as greater than 1000%, or even up to 1500%, as measured by ASTM D412 (Die C); or d) a tensile strength of at least 1 MPa, such as at least 6.0 MPa, such as at least 7.0 MPa, such as at least 8.0 MPa, such as at least 9.0 MPa, such as at least 10.0 MPa, or even up to 60 MPa, as measured by ASTM D412 (Die C). It will be appreciated that the values can be within a range between any of the minimum and maximum values noted above.

In an embodiment, the resulting article, such as a tube, may have improved properties compared to an article having an equivalent amount of non-bio-based silica filler and absent any bio-based silica filler. For instance, the article may have a decrease hysteresis compared to an article having an equivalent amount of non-bio-based silica filler and absent any bio-based silica filler. Further, the article may have an increased compression set compared to an article having an equivalent amount of non-bio-based silica filler and absent any bio-based silica filler. The improved hysteresis is indicative of an advantageous pump life when the article is a tube, such as a peristaltic pump tube.

In an embodiment, the use of the bio-based silica particles decreases the carbon dioxide emissions footprint during the processing of making the precursor components compared to a polymer composition absent the bio-based silica particles. In an embodiment, the polymer composition has a carbon dioxide emission that is decreased by at least 5%, such as at least 10%, such as at least 15%, such as at least 20%, or even at least 25% compared to a polymer composition absent the bio-based silica particles. In a particular embodiment, the polymer composition has a carbon dioxide emission that is decreased up to 30% compared to a polymer composition absent the bio-based silica articles. In a more particular embodiment, the use of a bio-based silica particles decreases the carbon dioxide emissions footprint of the polymer composition. It will be appreciated that the values can be within a range between any of the minimum and maximum values noted above.

In exemplary embodiments, the article can be used in a variety of applications. Applications for the article are numerous. In particular, the non-toxic nature of the silicone composition makes the article useful for any application where toxicity is undesired. For instance, the article has potential for FDA, ADCF, USP Class VI, NSF, European Pharmacopoeia compliant, United States Pharmacopoeia (USP) compliant, USP physiochemical compliant, ISO 10993 Standard for evaluating biocompatibility of a medical device, and other regulatory approvals. In a particular embodiment, the silicone composition may be non-cytotoxic, non-hemolytic, non-pyrogenic, animal-derived component-free, non-mutagenic, non-bacteriostatic, non-fungistatic, or any combination thereof.

In an embodiment, the silicone composition is any formed into any reasonable article, such as the tube, that may be used in applications such as industrial, medical applications, health care, biopharmaceutical, drinking water, food & beverage applications, dairy applications, laboratory applications, FDA applications, and the like. In an exemplary embodiment, although the article is primarily described as a tube, the article of the present invention may include any geometry envisioned; a connector, a molded part, a septum, an infusion sleeve, a pump diaphragm, a membrane, a valve, and the like. Any article is envisioned where the physical and mechanical properties of the silicone composition are advantageous.

Many different aspects and embodiments are possible. Some of those aspects and embodiments are described herein. After reading this specification, skilled artisans will appreciate that those aspects and embodiments are only illustrative and do not limit the scope of the present invention. Embodiments may be in accordance with any one or more of the items as listed below.

Embodiment 1. An article including a polymer composition, the polymer composition including a polymer matrix and bio-based silica particles, wherein the polymer composition has a tear strength of 14 N/mm to 100 N/mm ASTM 624 (Die C no slit).

Embodiment 2. The article in accordance with embodiment 1, wherein the polymer matrix includes a silicone elastomer, a polystyrene, a polyester, a silicone copolymer, silicone thermoplastic vulcanizate, a copolyester, a polyamide, a fluoropolymer, a polyethylene, a polypropylene, a polyether-ester copolymer, a thermoplastic urethane, a polyether amide block (PEBA) copolymer, a polyamide copolymer, a styrene block copolymer, a polycarbonate, a polyolefin elastomer, a thermoplastic vulcanizate, an ionomer, a polyoxymethylene (POM), an acrylonitrile butadiene styrene (ABS), an acetal, an acrylic, a polyvinyl chloride (PVC), a silane modified copolymer, a silane modified homopolymer, an epoxy, a urea-formaldehyde thermoset polymer, a phenol formaldehyde thermoset polymer, a blend, or combination thereof.

Embodiment 3. The article in accordance with any of the preceding embodiments, wherein the polymer matrix includes a silicone elastomer.

Embodiment 4. The article in accordance with embodiment 3, wherein the silicone elastomer includes at least one organosiloxane.

Embodiment 5. A method of providing an article including a silicone composition including: providing at least one organosiloxane and bio-based silica particles; and shaping the silicone composition into an article.

Embodiment 6. The article or the method in accordance with any one of embodiments 4 or 5, wherein the at least one organosiloxane includes a hydride-containing alkylsiloxane, a vinyl-containing alkylsiloxane, an aryl-containing alkylsiloxane, a hydroxy-containing alkylsiloxane, a halogen-containing alkylsiloxane, or combination thereof.

Embodiment 7. The article or the method in accordance with embodiment 6, wherein the at least one organosiloxane includes a hydride-containing alkylsiloxane, a vinyl-containing alkylsiloxane, or combination thereof.

Embodiment 8. The article or the method in accordance with embodiment 7, wherein the alkylsiloxane comprises an alkyl group having any one of a C1-C6 group or combination thereof.

Embodiment 9. The article or the method in accordance with any of the preceding embodiments, wherein the bio-based silica particles are derived from a biomass source comprising rice husks, wheat hulls, bamboo leaves, sugarcane bagasse, straw, barley husk, wheat straw, horsetail, sponges, oat hulls, corn stovers, nettle, hemp, musa, or combination thereof.

Embodiment 10. The article or the method in accordance with any of the preceding embodiments, wherein the bio-based silica particles have a surface area of 15 m²/g to 400 m²/g, such as 50 m²/g to 400 m²/g, such as 100 m²/g to 400 m²/g, such as 150 m²/g to 400 m²/g, such as 200 m²/g to 400 m²/g, such as 250 m²/g to 400 m²/g, or even 300 m²/g to 400 m²/g, as measured by BET.

Embodiment 11. The article or the method in accordance with any of the preceding embodiments, wherein the bio-based silica particles have a purity of at least 95%, such as 95% to 99%, as measured by ICP.

Embodiment 12. The article or the method in accordance with any of the preceding embodiments, wherein the bio-based silica particles are amorphous, as measured by X-Ray Diffraction (XRD).

Embodiment 13. The article or the method in accordance with any of the preceding embodiments, wherein the bio-based silica particles have an average particle size of 2 nanometers to 100 nanometers, such as 2 nanometers to 90 nanometers, such as 2 nanometers to 80 nanometers, such as 2 nanometers to 70 nanometers, such as 2 nanometers to 60 nanometers, such as 2 nanometers to 50 nanometers, such as 2 nanometers to 40 nanometers, such as 2 nanometers to 30 nanometers, such as 2 nanometers to 20 nanometers, or even 2 nanometers to 10 nanometers, as measured by SEM.

Embodiment 14. The article or the method in accordance with any of the preceding embodiments, wherein the bio-based silica particles are present at an amount of 1 wt. % to 45 wt. %, such as 5 wt. % to 40 wt. %, or even 10 wt. % to 30 wt. %, based on the total weight of the silicone composition.

Embodiment 15. The article or the method in accordance with any of the preceding embodiments, further including a catalyst, a crosslinker, an inhibitor, or combination thereof.

Embodiment 16. The article or the method in accordance with any of the preceding embodiments, wherein the polymer composition has a number average molecular weight of at least 50 g/mol, such as 50 g/mol to 1,000,000 g/mol, or even 200,000 g/mol to 1,000,000 g/mol.

Embodiment 17. The article or the method in accordance with any of the preceding embodiments, wherein the polymer composition has a weight average molecular weight of at least 50 g/mol, such as 50 g/mol to 1,000,000 g/mol, or even 200,000 g/mol to 1,000,000 g/mol.

Embodiment 18. The article or the method in accordance with any of the preceding embodiments, wherein the polymer composition has a tear strength greater than 15 N/mm, such as greater than 18 N/mm, or even greater than 20 N/mm, as measured by ASTM 624 (Die C no slit).

Embodiment 19. The article or the method in accordance with any of the preceding embodiments, wherein the polymer composition has a tear strength that is increased by at least 5%, such as at least 10%, such as at least 20%, such as at least 30%, such as at least 40%, such as at least 50%, such as at least 60%, or even at least 70% compared to a polymer composition absent a bio-based silica particle.

Embodiment 20. The article or the method in accordance with any of the preceding embodiments, wherein the polymer composition has an elongation at break of at least greater than 150%, such as greater than 250%, such as greater than 350%, such as greater than 450%, such as greater than 550%, such as greater than 650%, such as greater than 750%, such as greater than 1000%, or even up to 1500%, as measured by ASTM D412 (Die C).

Embodiment 21. The article or the method in accordance with any of the preceding embodiments, wherein the polymer composition has a tensile strength of at least 1 MPa, such as at least 6.0 MPa, such as at least 7.0 MPa, such as at least 8.0 MPa, such as at least 9.0 MPa, such as at least 10.0 MPa, or even up to 60 MPa, as measured by ASTM D412 (Die C).

Embodiment 22. The article or the method in accordance with any of the preceding embodiments, wherein the article has a shore A durometer of about 20 to about 90, as measured by ASTM D2240.

Embodiment 23. The article or the method in accordance with any of the preceding embodiments, wherein the article comprises a tube having an inner surface that defines a central lumen of the tube.

Embodiment 24. The article or the method in accordance with embodiment 23, wherein the tube has an inner diameter of 0.005 inches to 4.00 inches.

Embodiment 25. The article or the method in accordance with embodiments 23-24, wherein the tube has an outer diameter of 0.09 inches to 5.00 inches.

Embodiment 26. The article or the method in accordance with any one of embodiments 1-22, wherein the article includes a connector, a molded part, a septum, an infusion sleeve, a pump diaphragm, a membrane, or a valve.

Embodiment 27. A method of extracting a population of bio-based silica particles including: a) providing a biomass source; b) adding the biomass source to an aqueous acidic solution; c) removing the biomass source from the aqueous acidic solution; d) heating the biomass source to a temperature of at least 700 °C; and e) recovering a plurality of individual bio-based silica particles.

Embodiment 28. The method in accordance with embodiment 27, wherein the biomass source includes rice husks, wheat hulls, bamboo leaves, sugarcane bagasse, straw, barley husk, wheat straw, horsetail, sponges, oat hulls, corn stovers, nettle, hemp, musa, or combination thereof.

Embodiment 29. The method in accordance with any one of embodiments 27-28, wherein the acidic solution has a molar concentration of 0.1 to 10, such as 1 to 8, or even 1 to 5.

Embodiment 30. The method in accordance with any one of embodiments 27-29, wherein the acid in the aqueous acidic solution includes hydrochloric acid.

Embodiment 31. The method in accordance with any one of embodiments 27-30, wherein the biomass source is mixed in the aqueous acidic solution for at least 30 minutes to 180 minutes, such as 30 minutes to 120 minutes.

Embodiment 32. The method in accordance with any one of embodiments 27-31, wherein the heat is at a temperature of 700 °C to 900 °C.

Embodiment 33. The method in accordance with any one of embodiments 27-32, an airflow of 0.1 m/s to 0.5 m/s is maintained during heating of the biomass source in an atmosphere of air or an inert gas.

Embodiment 34. The method in accordance with any one of embodiments 27-33, wherein the bio-based silica particles have a surface area of 15 m²/g to 400 m²/g, such as 50 m²/g to 400 m²/g, such as 100 m²/g to 400 m²/g, such as 150 m²/g to 400 m²/g, such as 200 m²/g to 400 m²/g, such as 250 m²/g to 400 m²/g, or even 300 m²/g to 400 m²/g, as measured by BET.

Embodiment 35. The method in accordance with any one of embodiments 27-34, wherein the bio-based silica particles have a purity of at least 95%, such as 95% to 99%, as measured by ICP.

Embodiment 36. The method in accordance with any one of embodiments 27-35, wherein the bio-based silica particles are amorphous, as measured by X-Ray Diffraction (XRD).

Embodiment 37. The method in accordance with any one of embodiments 27-36, wherein the bio-based silica particles have an average particle size of 2 nanometers to 100 nanometers, such as 2 nanometers to 90 nanometers, such as 2 nanometers to 80 nanometers, such as 2 nanometers to 70 nanometers, such as 2 nanometers to 60 nanometers, such as 2 nanometers to 50 nanometers, such as 2 nanometers to 40 nanometers, such as 2 nanometers to 30 nanometers, such as 2 nanometers to 20 nanometers, or even 2 nanometers to 10 nanometers, as measured by SEM.

Embodiment 38. A tube including a silicone composition, the silicone composition including at least one organosiloxane and bio-based silica particles.

Embodiment 39. The tube in accordance with embodiment 38, wherein the at least one organosiloxane includes a hydride-containing alkylsiloxane, a vinyl-containing alkylsiloxane, an aryl-containing alkylsiloxane, a hydroxy-containing alkylsiloxane, a halogen-containing alkylsiloxane, or combination thereof.

Embodiment 40. The tube in accordance with embodiment 39, wherein the alkylsiloxane includes an alkyl group having any one of a C1-C6 group or combination thereof.

Embodiment 41. The tube in accordance with any one of embodiments 38-40, wherein the bio-based silica particles are derived from a biomass source including rice husks, wheat hulls, bamboo leaves, sugarcane bagasse, straw, barley husk, wheat straw, horsetail, sponges, oat hulls, corn stovers, nettle, hemp, musa, or combination thereof.

Embodiment 42. The tube in accordance with any one of embodiments 38-41, wherein the bio-based silica particles have a surface area of 15 m²/g to 400 m²/g, such as 50 m²/g to 400 m²/g, such as 100 m²/g to 400 m²/g, such as 150 m²/g to 400 m²/g, such as 200 m²/g to 400 m²/g, such as 250 m²/g to 400 m²/g, or even 300 m²/g to 400 m²/g, as measured by BET.

Embodiment 43. The tube in accordance with any one of embodiments 38-42, wherein the bio-based silica particles have a purity of at least 95%, such as 95% to 99%, as measured by ICP.

Embodiment 44. The tube in accordance with any one of embodiments 38-43, wherein the bio-based silica particles are amorphous, as measured by X-Ray Diffraction (XRD).

Embodiment 45. The tube in accordance with any one of embodiments 38-44, wherein the bio-based silica particles have an average particle size of 2 nanometers to 100 nanometers, such as 2 nanometers to 90 nanometers, such as 2 nanometers to 80 nanometers, such as 2 nanometers to 70 nanometers, such as 2 nanometers to 60 nanometers, such as 2 nanometers to 50 nanometers, such as 2 nanometers to 40 nanometers, such as 2 nanometers to 30 nanometers, such as 2 nanometers to 20 nanometers, or even 2 nanometers to 10 nanometers, as measured by SEM.

Embodiment 46. The tube in accordance with any one of embodiments 38-45, wherein the bio-based silica particles are present at an amount of 1 wt. % to 45 wt. %, such as 5 wt. % to 40 wt. %, or even 10 wt. % to 30 wt. %, based on the total weight of the silicone composition.

Embodiment 47. The tube in accordance with any one of embodiments 38-46, wherein the silicone composition further includes a catalyst, a crosslinker, an inhibitor, or combination thereof.

Embodiment 48. The tube in accordance with any one of embodiments 38-47, wherein the silicone composition has a number average molecular weight of at least 50 g/mol, such as 50 g/mol to 1,000,000 g/mol, or even 200,000 g/mol to 1,000,000 g/mol.

Embodiment 49. The tube in accordance with any one of embodiments 38-48, wherein the silicone composition has a weight average molecular weight of at least 50 g/mol, such as 50 g/mol to 1,000,000 g/mol, or even 200,000 g/mol to 1,000,000 g/mol.

Embodiment 50. The tube in accordance with any one of embodiments 38-49, wherein the silicone composition has a tear strength greater than 15 N/mm, such as greater than 18 N/mm, or even greater than 20 N/mm, as measured by ASTM 624 (Die C no slit).

Embodiment 51. The tube in accordance with any one of embodiments 38-50, wherein the silicone composition has tear strength that is increased by at least 5%, such as at least 10%, such as at least 20%, such as at least 30%, such as at least 40%, such as at least 50%, such as at least 60%, or even at least 70% compared to a polymer composition absent a bio-based silica particle.

Embodiment 52. The tube in accordance with any one of embodiments 38-51, wherein the silicone composition has an elongation at break of at least greater than 150%, such as greater than 250%, such as greater than 350%, such as greater than 450%, such as greater than 550%, such as greater than 650%, such as greater than 750%, such as greater than 1000%, or even up to 1500%, as measured by ASTM D412 (Die C).

Embodiment 53. The tube in accordance with any one of embodiments 38-52, wherein the article has a tensile strength of at least 1 MPa, such as at least 6.0 MPa, such as at least 7.0 MPa, such as at least 8.0 MPa, such as at least 9.0 MPa, such as at least 10.0 MPa, or even up to 60 MPa, as measured by ASTM D412 (Die C).

Embodiment 54. The tube in accordance with any one of embodiments 38-53, wherein the silicone composition has a shore A durometer of about 20 to about 90, as measured by ASTM D2240.

Embodiment 55. The tube in accordance with any one of embodiments 38-54, having an inner surface that defines a central lumen of the tube.

Embodiment 56. The tube in accordance with any one of embodiments 38-55, having an inner diameter of 0.005 inches to 4.00 inches.

Embodiment 57. The tube in accordance with any one of embodiments 38-56, having an outer diameter of 0.09 inches to 5.00 inches.

Embodiment 58. The tube in accordance with any one of embodiments 38-57, having a decreased hysteresis compared to a tube having an equivalent amount of non-bio-based silica filler and absent any bio-based silica filler

Embodiment 59. The article in accordance with any of the preceding embodiments, wherein the bio-based silica particles are surface treated.

Embodiment 60. The article in accordance with embodiment 58, wherein the surface treatment comprises a silane surface treatment.

Embodiment 61. The article in accordance with embodiment 59, wherein the silane surface treatment comprises trimethoxy(octyl)silane.

The concepts described herein will be further described in the following examples, which do not limit the scope of the disclosure described in the claims. The following examples are provided to better disclose and teach processes and compositions of the present invention. They are for illustrative purposes only, and it must be acknowledged that minor variations and changes can be made without materially affecting the spirit and scope of the invention as recited in the claims that follow.

### Examples

### Example 1

Preparation of biomass silica was as follows: A rice hull (RH) sample, obtained from Composition Materials CO., Inc., was pretreated using 2.7 M hydrochloric acid (HCl, 35%, Fisher Scientific) at 95 °C for 2 hours. The sample was then rinsed three times with deionized water to remove residual components and subsequently dried in an oven at 80 °C overnight. Once thoroughly dried, the sample was ground for further use. 10 g RH was processed in a box furnace at 700 °C for 2 hours under ambient conditions, yielding 3 g of silica with approximately 95% purity.

The biomass silica was compounded into a commercially available silicone gum having a shore A hardness of 60 (“Duro 60”) and 90 (“Duro 90”). Silicone compositional amounts and resulting properties can be seen in Tables 1 and 2. Tensile properties and toughness were measured according to ASTM D412, tear strength according to ASTM D624, and hardness (shore A) according to ASTM D2240 at ambient temperature.

TABLE 1
Comparison of the silicone sample with biomass
silica and the mechanical properties.

| Silicone | | | | | |
|---|---|---|---|---|---|
| Tubing | RH-silica | | Tensile | | Tear |
| Raw | Loading | Hardness | Strength | Elongation | Strength |
| Materials | amount | (ShA) | (MPa) | Break (%) | (N/mm) |
| Duro 60 | — | 72 | 14.7 ± 0.34 | 1262.4 ± 46.2 | 24.3 ± 0.74 |
| Silicone | 5 wt. % | 72.6 | 12.8 ± 0.40 | 1103.5 ± 112.9 | 22.5 ± 3.7 |
| Gum | 10 wt. % | 76.0 | 11.01 ± 0.40 | 1004.2 ± 105 | 28.2 ± 2.3 |
| | 15 wt. % | 76.0 | 11.3 ± 0.98 | 1110.5 ± 44.0 | 27.0 ± 0.32 |

TABLE 2
The table shows the mechanical properties evaluation of silicone elastomer
by incorporating commercially used silica and biomass-Silica.

| Silicone | | | | | | | |
|---|---|---|---|---|---|---|---|
| Tubing | | Silica | | Tensile | | Tear | Tear |
| Raw | | loading | Hardness | Strength | Elongation | Strength | Strength |
| Materials | Silica | amount | (ShA) | (MPa) | Break (%) | (N/mm) | Improvement |
| Duro 90 | No | — | 90 | 15.4 | 160 | 12.7 | — |
| Silicone | silica | | | | | | |
| Gum | Biomass | 10 | 85.1 | 12.7 | 378.5 | 22.2 | +74.8% |
| | Silica | wt. % | | | | | |
| | Evonik | 10 | 86 | 19.1 | 127 | 18.6 | +46.9% |
| | R812s | wt. % | | | | | |

### Example 2

The base elastomer was a commercially available silicone elastomer composition including a vinyl-terminated polydimethylsiloxane (PDMS) base resin and a platinum-based curing catalyst. For filled formulations, reinforcing fillers, including biomass silica (rice husk derived) and commercially available non-bio-based silica, were first incorporated into the PDMS base resin using a speed mixer operated at 3000 rpm for 2 minutes, yielding a substantially homogeneous mixture. Following filler dispersion, the platinum catalyst component was added to the mixture and further mixed to ensure uniform distribution. The resulting compositions were cast or molded into test specimens and thermally cured at 185 °C for 10 minutes. No post-curing step was performed.

Table 3 shows mechanical properties of silicone elastomer compositions with different filler types and loadings. Samples were prepared by dispersing fillers into the base resin using a speed mixer at 3000 rpm for 2 minutes, followed by the addition of a platinum catalyst. All specimens were cured at 185 °C for 10 minutes with no post-cure. Tensile properties and toughness were measured according to ASTM D412, tear strength according to ASTM D624, and hardness according to ASTM D2240 at ambient temperature.

TABLE 3

| | Tensile | | Young's | 100% | Toughness | Hardness |
|---|---|---|---|---|---|---|
| Sample | Strength | Tear Strength | modulus | modulus | (MJ/m³) | (ShA) |
| PDMS Kit | 1.98 ± 0.5 MPa | 20.0 ± 2.0 lb/in | 0.97 MPa | 0.98 MPa | 0.47 | 55 |
| PDMS Kit-15% biomass silica | 4.03 ± 0.4 MPa | 58.9 ± 2.0 lb/in | 2.74 MPa | 3.93 MPa | 1.7 | 74 |
| PDMS Kit-10% biomass silica | 3.63 ± 0.2 MPa | 44.2 ± 1.5 lb/in | 2.83 MPa | 3.68 MPa | 1.7 | 69 |
| PDMS Kit-10% commercial | 3.13 ± 0.4 MPa | 42.8 ± 0.8 lb/in | 2.72 MPa | 2.89 MPa | 1.7 | 65 |
| silica | | | | | | |
| PDMS Kit-15% commercial | N/A | N/A | N/A | N/A | N/A | N/A |
| silica | | | | | | |

The results demonstrated that biomass-derived silica provided superior reinforcement and processability in silicone elastomer compositions compared to conventional carbon black fillers. As shown in Table 1, incorporation of biomass-derived silica into the silicone elastomer composition substantially increased tensile strength, tear strength, elastic modulus, toughness, and hardness relative to the unfilled elastomer. Compositions containing 10-15 wt. % RH silica exhibited tensile strengths above 3.6 MPa, tear strengths exceeding 44 lb/in, Young's modulus values of approximately 2.7-2.8 MPa, and toughness values of approximately 1.7 MJ/m³, while remaining readily processable and capable of forming homogeneous, testable specimens.

In contrast, silicone compositions filled with carbon black showed inferior overall performance and limited processability at comparable loadings. While the addition of a 10 wt. % non-bio-based silica in the silicone elastomer formulation can be processed and tested, it exhibited lower tensile strength, reduced modulus, and lower hardness relative to RH silica-filled compositions. Notably, a silicone elastomer composition containing 15 wt. % non-bio-based silica could not be uniformly mixed into the silicone matrix, preventing fabrication of suitable test specimens and precluding mechanical characterization. These results indicated that biomass-derived silica enabled higher effective reinforcement at increased filler loadings without compromising mixability, whereas conventional carbon black fillers led to processing limitations at similar or higher concentrations.

### Example 3

Pt catalyzed high consistency silicone rubber (Duro 60 gum-cured elastomer) was evaluated in an unfilled form and in a filled form containing 10 wt. % biomass-derived silica compounded into the silicone gum to form a substantially uniform elastomer compound. Test specimens were molded and thermally cured at 185 °C, followed by post-curing for 4 h. Cyclic hysteresis testing was conducted using ASTM Type IV dog-bone tensile specimens in a repeated loading-unloading protocol in which the specimen was pulled in tension to a specified extension and crosshead speed and then returned to the starting position; this load-unload sequence was repeated for multiple cycles (including Cycle 10). Hysteresis (%) was calculated from the cyclic response as the energy loss between loading and unloading (area of the loop) normalized to the input energy for the corresponding cycle.

The tables below report the unfilled Duro 60 gum-cured elastomer and the calculated hysteresis (%) at selected cycles (Cycles 1-5 and 10).

TABLE 4

| | Hysteresis (%), | Hysteresis (%), | Hysteresis (%), |
|---|---|---|---|
| | Cycle 1 | Cycle 2 | Cycle 3 |
| 1 | 38.07965 | 31.81818 | 28.33454 |
| 2 | 40.29818 | 33.97820 | 30.44311 |
| Mean | 39.18892 | 32.89819 | 29.38882 |
| Range | 2.21853 | 2.16002 | 2.10857 |

TABLE 5

| | Hysteresis (%), | Hysteresis (%), | Hysteresis (%), |
|---|---|---|---|
| | Cycle 4 | Cycle 5 | Cycle 10 |
| 1 | 25.78905 | 23.73714 | 17.25623 |
| 2 | 27.77831 | 25.62639 | 18.78102 |
| Mean | 26.78368 | 24.68176 | 18.01863 |
| Range | 1.98926 | 1.88924 | 1.52479 |

The tables below report the elastomer of Duro 60 gum compounded with 10 wt. % biomass-derived silica and the calculated hysteresis (%) at selected cycles (Cycles 1-5 and 10).

TABLE 6

| | Hysteresis (%), | Hysteresis (%), | Hysteresis (%), |
|---|---|---|---|
| | Cycle 1 | Cycle 2 | Cycle 3 |
| 1 | 31.29636 | 25.26734 | 22.13838 |
| 2 | 33.46681 | 27.15312 | 23.82749 |
| Mean | 32.38158 | 26.21023 | 22.98293 |
| Range | 2.17044 | 1.88578 | 1.68912 |

TABLE 7

| | Hysteresis (%), | Hysteresis (%), | Hysteresis (%), |
|---|---|---|---|
| | Cycle 4 | Cycle 5 | Cycle 10 |
| 1 | 19.92149 | 18.17978 | 12.94540 |
| 2 | 21.42066 | 19.53917 | 13.89419 |
| Mean | 20.67108 | 18.85948 | 13.41979 |
| Range | 1.49917 | 1.35938 | 0.94880 |

The cyclic hysteresis data showed that incorporating 10 wt. % biomass-derived silica into the Duro 60 HCR silicone gum reduced energy dissipation per cycle and improved cyclic stability relative to the unfilled control. Specifically, the mean hysteresis decreased from 39.19%/(unfilled) to 32.38% (10 wt. % biomass silica) at Cycle 1, and remained lower throughout cycling, reaching 18.02% (unfilled) versus 13.42% (biomass silica) by Cycle 10. Across Cycles 1, 2, 3, 4, 5, and 10, the biomass-silica formulation exhibited an absolute reduction of approximately 4.60-6.81%, corresponding to a relative reduction of approximately 17-26% compared with the unfilled material (based on the reported mean values). Because hysteresis in cyclic tension reflects the fraction of mechanical input energy dissipated (e.g., as internal friction/heat), these reductions indicated that the biomass-silica-filled elastomer exhibited higher resilience and lower heat build-up potential under repeated deformation, which is desirable for dynamic sealing and pumping applications where cyclic loading can drive temperature rise and mechanical fatigue. Accordingly, the hysteresis provides evidence of an advantageous and improved pump life with the use of the biomass silica in the HCR silicone gum compared to an unfilled HCR silicone gum.

### Example 4. Surface Modification of the Biomass-Derived Silica

Biomass-derived silica was first dried at 120 °C under vacuum for at least 4 h to remove physically adsorbed moisture and activate surface silanol groups. After cooling to room temperature, the dried silica (e.g., 5 g) was dispersed in anhydrous ethanol (or toluene) under magnetic stirring to form a homogeneous suspension. Trimethoxy(octyl)silane was separately pre-hydrolyzed by mixing with a small amount of deionized water (molar ratio H₂O:silane≈1-3) and adjusting the solution to mildly acidic conditions (pH~4-5 using acetic acid). The hydrolyzed silane solution was then added dropwise to the silica suspension under continuous stirring. The reaction mixture was maintained at 60-80 °C for 4-6 h to promote condensation between the silanol groups of the silane and the surface —Si—OH groups of the biomass silica, forming covalent Si—O—Si linkages. After completion, the treated silica was collected by filtration, washed thoroughly with ethanol to remove unreacted or physisorbed silane species, and dried at 80-100 °C under vacuum overnight. The resulting octyl-functionalized biomass silica exhibited a hydrophobic surface due to the grafted alkyl chains, suitable for improved compatibility with non-polar polymer matrices.

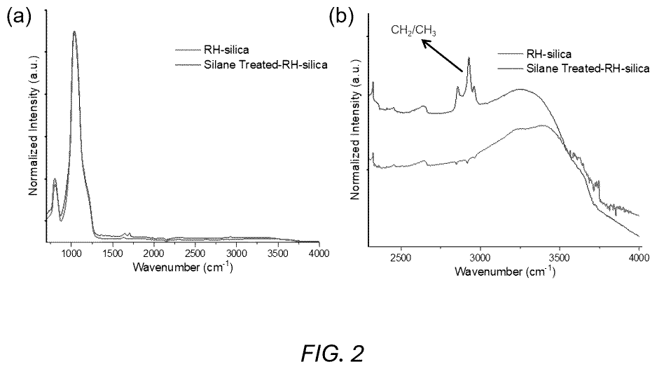

FIG. 2 illustrates the FTIR spectra of untreated biomass-derived rice husk (RH) silica and silane-treated RH silica. (a) Full spectral range (400-4000 cm⁻¹) showing preservation of the amorphous silica framework after surface modification. (b) Enlarged region (2400-4000 cm⁻¹) highlighting the appearance of alkyl C—H stretching bands (CH₂/CH₃) in silane-treated RH silica, confirming successful grafting of octyl groups onto the silica surface.

FTIR spectroscopy provided molecular-level evidence of successful surface functionalization of biomass-derived silica via silane grafting. As shown in FIG. 2a, both untreated RH silica and silane-treated RH silica exhibited strong absorption bands characteristic of amorphous silica, including Si—O—Si asymmetric stretching vibrations centered around approximately 1000-1100 cm⁻¹, indicating that the inorganic silica network remained intact following chemical modification. The absence of new peaks in the silica fingerprint region further confirmed that the bulk silica structure was preserved and that the modification was confined to the particle surface.

In contrast, clear spectral differences were observed in the high-wavenumber region shown in FIG. 2b. Untreated RH silica exhibited a broad absorption band between approximately 3200 and 3600 cm⁻¹, corresponding to O—H stretching vibrations of surface silanol groups and physically adsorbed moisture. Following silane treatment, the intensity of this O—H band was reduced, consistent with condensation reactions between surface —Si—OH groups of the biomass silica and hydrolyzed trimethoxy(octyl)silane. Concurrently, new absorption bands appeared at approximately 2850-2950 cm⁻¹, which are assigned to symmetric and asymmetric C—H stretching vibrations of CH₂ and CH₃ groups from the grafted octyl chains. The presence of these alkyl-related bands, combined with the reduction of silanol-related absorption, confirmed the formation of covalent Si—O—Si linkages between the silane and the silica surface rather than simple physical adsorption.

These spectral features demonstrated that the biomass-derived silica was chemically modified to exhibit a hydrophobic, organophilic surface, imparted by covalently bound alkyl chains. Such surface functionalization reduced silica-silica hydrogen bonding and improved compatibility with non-polar polymer matrices, including silicone elastomers. Accordingly, the FTIR results substantiated that silane-treated biomass silica provided a chemically tailored filler surface that supports improved dispersion, reduced interfacial energy loss, and enhanced mechanical performance in elastomeric compositions, as described elsewhere herein.

Table 8 shows the mechanical properties of Duro 60 silicone gum elastomer containing 10 wt. % biomass-derived silica, with and without surface silane treatment. Hardness, tensile strength, elongation at break, and tear strength were measured under identical processing and curing conditions. Tear strength improvement is reported relative to unfilled Duro 60 silicone gum. Mechanical properties were measured under the standards given within the Examples.

TABLE 8

| Silicone | | | | | | | |
|---|---|---|---|---|---|---|---|
| Tubing | | | | Tensile | | Tear | Tear |
| Raw | Loading | Silane | Hardness | Strength | Elongation | Strength | Strength |
| Materials | amount | Treated | (ShA) | (MPa) | Break (%) | (N/mm) | Improvement |
| Duro 60 | — | — | 72 | 14.7 ± 0.34 | 1262.4 ± 46.2 | 24.3 ± 0.74 | — |
| | 10 wt. % | — | 76.0 | 11.01 ± 0.40 | 1004.2 ± 105 | 28.2 ± 2.3 | +16.0% |
| | 10 wt. % | Yes | 71.1 | 14.0 ± 2.07 | 1666.51 ± 45.0 | 29.2 ± 0.37 | +20.2% |

The data in Table 8 demonstrated that surface treatment of biomass-derived silica resulted in enhanced reinforcement efficiency when incorporated at the same 10 wt. % loading level in Duro 60 silicone gum, compared to untreated biomass silica. The unfilled Duro 60 silicone gum exhibited a hardness of 72 ShA, a tensile strength of 14.7±0.34 MPa, an elongation at break of 1262±46%, and a tear strength of 24.3±0.74 N/mm. Incorporation of 10 wt. % untreated biomass silica increased hardness to 76.0 ShA and tear strength to 28.2±2.3 N/mm, corresponding to a 16.0% tear strength improvement, but was accompanied by a reduction in tensile strength to 11.01±0.40 MPa and a decrease in elongation at break to 1004±105%, indicating increased stiffness and reduced ductility.

In contrast, incorporation of 10 wt. % surface-treated biomass silica yielded an elastomer with a hardness of 71.1 ShA, comparable to the unfilled baseline, while achieving a tensile strength of 14.0±2.07 MPa and a substantially increased elongation at break of 1666±45%. The tear strength further increased to 29.2±0.37 N/mm, corresponding to a 20.2% improvement relative to the unfilled material and exceeding the tear strength obtained with untreated biomass silica at the same loading level. These results showed that surface-treated biomass silica provided higher tear resistance while preserving tensile strength and extensibility, thereby delivering a more favorable balance of mechanical properties than untreated biomass silica in Duro 60 silicone gum compositions.

### Example 5

Elemental oxide of rice-hull derived biomass silica and commercially available silica was measured by ICP. Results can be seen in Tables 9 and 10.

TABLE 9
Elemental oxide composition of rice hull-derived by ICP.
Rice Hull Silica Analysis

| | | Low Reporting |
|---|---|---|
| Element | Wt. % | Wt. % |
| Al₂O₃ | 0.04 | 0.01 |
| B₂O₃ | 0.03 | 0.01 |
| BaO | 0.010 | 0.001 |
| CaO | 0.01 | 0.01 |
| CoO | <0.002 | 0.002 |
| Cr₂O₃ | <0.002 | 0.002 |
| CuO | <0.002 | 0.002 |
| Fe₂O₃ | <0.01 | 0.01 |
| HfO₂ | <0.004 | 0.004 |
| K₂O | <0.01 | 0.01 |
| Li₂O | <0.001 | 0.001 |
| MgO | 0.005 | 0.001 |
| MnO₂ | 0.004 | 0.001 |
| Na₂O | <0.02 | 0.02 |
| NiO | <0.002 | 0.002 |
| P₂O₅ | 0.07 | 0.01 |
| Sb₂O₃ | <0.01 | 0.01 |
| SiO₂ | 94.5 | 0.02 |
| SnO₂ | <0.01 | 0.01 |
| SrO | <0.001 | 0.001 |
| Ta₂O₅ | <0.005 | 0.005 |
| TiO₂ | 0.002 | 0.001 |
| V₂O₅ | <0.002 | 0.002 |
| Y₂O₃ | <0.001 | 0.001 |
| ZnO | <0.001 | 0.001 |
| ZrO₂ | <0.002 | 0.002 |

TABLE 10
Elemental oxide composition of commercial silica by ICP.
Commercial Silica Analysis

| | | Low Reporting |
|---|---|---|
| Element | Wt. % | Wt. % |
| SiO₂ | 99.8 | 0.02 |

The ICP analyses clearly show the purity difference between the bio-based biomass silica versus the commercially available silica.

In the foregoing specification, the concepts have been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of the invention.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

After reading the specification, skilled artisans will appreciate that certain features are, for clarity, described herein in the context of separate embodiments, and may also be provided in combination in a single embodiment. Conversely, various features that are, for brevity, described in the context of a single embodiment, may also be provided separately or in any subcombination. Further, references to values stated in ranges include each and every value within that range.

What is claimed is:

1. An article comprising a polymer composition, the polymer composition comprising a polymer matrix and bio-based silica particles, wherein the article has a shore A durometer of about 20 to about 90, as measured by ASTM D2240.

2. The article in accordance with claim 1, wherein the polymer matrix comprises a silicone elastomer, a polystyrene, a polyester, a silicone copolymer, silicone thermoplastic vulcanizate, a copolyester, a polyamide, a fluoropolymer, a polyethylene, a polypropylene, a polyether-ester copolymer, a thermoplastic urethane, a polyether amide block (PEBA) copolymer, a polyamide copolymer, a styrene block copolymer, a polycarbonate, a polyolefin elastomer, a thermoplastic vulcanizate, an ionomer, a polyoxymethylene (POM), an acrylonitrile butadiene styrene (ABS), an acetal, an acrylic, a polyvinyl chloride (PVC), a silane modified copolymer, a silane modified homopolymer, an epoxy, a urea-formaldehyde thermoset polymer, a phenol formaldehyde thermoset polymer, a blend, or combination thereof.

3. The article in accordance with claim 1, wherein the polymer matrix comprises a silicone elastomer.

4. The article in accordance with claim 3, wherein the silicone elastomer comprises at least one organosiloxane.

5. The article in accordance with claim 4, wherein the at least one organosiloxane comprises a hydride-containing alkylsiloxane, a vinyl-containing alkylsiloxane, an aryl-containing alkylsiloxane, a hydroxy-containing alkylsiloxane, a halogen-containing alkylsiloxane, or combination thereof.

6. The article in accordance with claim 5, wherein the alkylsiloxane comprises an alkyl group having any one of a C1-C6 group or combination thereof.

7. The article in accordance with claim 1, wherein the bio-based silica particles are derived from a biomass source comprising rice husks, wheat hulls, bamboo leaves, sugarcane bagasse, straw, barley husk, wheat straw, horsetail, sponges, oat hulls, corn stovers, nettle, hemp, musa, or combination thereof.

8. The article in accordance with claim 1, wherein the bio-based silica particles have a surface area of 15 m²/g to 400 m²/g, such as 50 m²/g to 400 m²/g, such as 100 m²/g to 400 m²/g, such as 150 m²/g to 400 m²/g, such as 200 m²/g to 400 m²/g, such as 250 m²/g to 400 m²/g, or even 300 m²/g to 400 m²/g, as measured by BET.

9. The article in accordance with claim 1, wherein the bio-based silica particles have a purity of 95% to 99%, as measured by ICP.

10. The article in accordance with claim 1, wherein the bio-based silica particles have an average particle size of 2 nanometers to 100 nanometers, such as 2 nanometers to 90 nanometers, such as 2 nanometers to 80 nanometers, such as 2 nanometers to 70 nanometers, such as 2 nanometers to 60 nanometers, such as 2 nanometers to 50 nanometers, such as 2 nanometers to 40 nanometers, such as 2 nanometers to 30 nanometers, such as 2 nanometers to 20 nanometers, or even 2 nanometers to 10 nanometers, as measured by SEM.

11. The article in accordance with claim 1, wherein the bio-based silica particles are present at an amount of 1 wt. % to 45 wt. %, such as 5 wt. % to 40 wt. %, or even 10 wt. % to 30 wt. %, based on the total weight of the silicone composition.

12. The article in accordance with claim 1, further comprising a catalyst, a crosslinker, an inhibitor, or combination thereof.

13. The article in accordance with claim 1, wherein the polymer composition has a tear strength of 14 N/mm to 100 N/mm ASTM 624 (Die C no slit).

14. The article in accordance with claim 1, wherein the polymer composition has at least one of the following properties:
a) a tear strength that is increased by at least 5%, such as at least 10%, such as at least 20%, such as at least 30%, such as at least 40%, such as at least 50%, such as at least 60%, or even at least 70% compared to a polymer composition absent a bio-based silica particle;
b) an elongation at break of at least greater than 150%, such as greater than 250%, such as greater than 350%, such as greater than 450%, such as greater than 550%, such as greater than 650%, such as greater than 750%, such as greater than 1000%, or even up to 1500%, as measured by ASTM D412 (Die C); or
c) a tensile strength of at least 1 MPa, such as at least 6.0 MPa, such as at least 7.0 MPa, such as at least 8.0 MPa, such as at least 9.0 MPa, such as at least 10.0 MPa, or even up to 60 MPa, as measured by ASTM D412 (Die C).

15. The article in accordance with claim 1, wherein the article comprises a tube having an inner surface that defines a central lumen of the tube.

16. A method of providing an article comprising a silicone composition comprising:
providing at least one organosiloxane and at least a portion of bio-based silica particles; and
shaping the silicone composition into an article.

17. A tube comprising a silicone composition, the silicone composition comprising at least one organosiloxane and bio-based silica particles.

18. The tube in accordance with claim 17, wherein the at least one organosiloxane comprises a hydride-containing alkylsiloxane, a vinyl-containing alkylsiloxane, an aryl-containing alkylsiloxane, a hydroxy-containing alkylsiloxane, a halogen-containing alkylsiloxane, or combination thereof.

19. The tube in accordance with claim 17, wherein the bio-based silica particles are derived from a biomass source comprising rice husks, wheat hulls, bamboo leaves, sugarcane bagasse, straw, barley husk, wheat straw, horsetail, sponges, oat hulls, corn stovers, nettle, hemp, musa, or combination thereof.

20. The tube in accordance with claim 17, having a decreased hysteresis compared to a tube having an equivalent amount of non-bio-based silica filler and absent any bio-based silica filler.
